(19) United States
(12) Patent Application Publication
(10) Pub. No.: US 2014/0354832 A1
(43) Pub. Date: Dec. 4, 2014

(54) INFORMATION PROCESSING APPARATUS, IMAGE CAPTURE SYSTEM, INFORMATION PROCESSING METHOD, AND RECORDING MEDIUM

(71) Applicant: CASIO COMPUTER CO., LTD., Tokyo (JP)

(72) Inventors: Kenji IWAMOTO, Tokyo (JP); Kazunori YANAGI, Tokyo (JP); Takashi ONODA, Tokyo (JP); Taku KOREKI, Tokyo (JP)

(73) Assignee: CASIO COMPUTER CO., LTD., Tokyo (JP)

(21) Appl. No.: 14/276,640

(22) Filed: May 13, 2014

(30) Foreign Application Priority Data
May 31, 2013 (JP) 2013-115188

(51) Int. Cl. H04N 5/232

(52) U.S. Cl. CPC H04N 5/23203
USPC 348/207.11

(57) ABSTRACT

An information processing apparatus includes: a communication unit that communicates with an external image capture apparatus; a positioning unit that estimates a moving distance of the image capture apparatus; and a transmission unit that transmits to the external image capture apparatus, an instruction to control the image capture apparatus, depending on the moving distance estimated by the positioning unit, via the communication unit.

This application is based on and claims the benefit of priority from Japanese Patent Application No. 2013-115188, filed on 31 May 2013, the content of which is incorporated herein by reference.

### BACKGROUND OF THE INVENTION

1. Field of the Invention

The present invention relates to an information processing apparatus, an image capture system, an information processing method, and a recording medium.

2. Related Art

Conventionally, an image capture apparatus has been known which acquires a current position by GPS (Global Positioning System) and records the current position along with captured image data (for example, refer to Japanese Unexamined Patent Application, Publication No. 2007-020078). With such a configuration, it becomes possible for a viewer viewing the captured image later to readily know a position where the image was captured.

Furthermore, conventionally, it has been configured such that a fixed image capture apparatus repeats an image capture operation every predetermined time period. With such a configuration, since it becomes possible to readily recognized visually a temporal shift of a specific space (a fixed space), which facilitates fixed point observation.

However, since currently various demands are being made for images for log, conventional technologies including the technology disclosed in Japanese Unexamined Patent Application, Publication No. 2007-020078 have not satisfied such various demands.

More specifically, for example, a demand has been made desiring for captured images that depend on various moving distances, i.e. each predetermined distance (for example, every 1 kilometer), to be stored for log when capturing images a plurality of times while an image capture apparatus is moving. However, conventional technologies including the technology disclosed in Japanese Unexamined Patent Application, Publication No. 2007-020078 have not satisfied such a demand.

Furthermore, when trying to satisfy such a demand with a single image capture apparatus, it becomes necessary to mount a device for acquiring information indicating a current position, a result of which other problems arise in that the image capture apparatus becomes larger in size as well as the consumed power of the image capture apparatus becoming greater.

### SUMMARY OF THE INVENTION

The present invention addresses such conditions and it is an object of the present invention to realize a technology of storing captured images for log that depend on various moving distances when capturing images a plurality of times while an image capture apparatus is moving. According to an embodiment of the present invention, an information processing apparatus includes: a communication unit that communicates with an external image capture apparatus; a positioning unit that estimates a moving distance of the image capture apparatus; and a transmission unit that transmits to the external image capture apparatus, an instruction to control the image capture apparatus, depending on the moving distance estimated by the positioning unit, via the communication unit. According to an embodiment of the present invention, an image capture system to which an image capture apparatus and a terminal including a positioning unit that estimates a moving distance of the image capture apparatus are communicably connected via a communication unit, in which the terminal includes a transmission unit that transmits an instruction to control the image capture apparatus, based on the moving distance estimated by the positioning unit, to the image capture apparatus via the communication unit, and the image capture apparatus includes a captured image transmission unit that transmits the image captured to the terminal. According to an embodiment of the present invention, an information processing method executed by an information processing apparatus including a communication unit that communicates with an external image capture apparatus, includes: an calculating step of estimating a moving distance of the image capture apparatus; and a transmitting step of transmitting an instruction to control the image capture apparatus, based on the moving distance estimated by the calculating step, to the image capture apparatus via the communication unit. According to an embodiment of the present invention, a non-transitory storage medium encoded with a computer-readable program that enables a computer included in an information processing apparatus that communicates with an external image capture apparatus to execute functions as: an calculating unit of estimating a moving distance of the image capture apparatus; and a transmitting unit of transmitting an instruction to control the image capture apparatus, based on the moving distance estimated by the calculating unit, to the image capture apparatus via the communication unit.

### BRIEF DESCRIPTION OF THE DRAWINGS

FIG. 1 is a schematic diagram showing a configuration of an image capture system according to an embodiment of the present invention;

FIG. 2 is a block diagram showing a hardware configuration of an information processing apparatus according to an embodiment of the present invention in the image capture system of FIG. 1;

FIG. 3 is a functional block diagram showing a functional configuration for executing image capture control processing among the functional configurations of the information processing apparatus of FIG. 2;

FIG. 4 is a flowchart illustrating a flow of image capture control processing executed by the information processing apparatus of FIG. 2 having the functional configuration of FIG. 3; and

FIG. 5 is a schematic diagram showing a summary of log moving images created in the image capture control processing of FIG. 4.

### DETAILED DESCRIPTION OF THE INVENTION

In the following, embodiments of the present invention are explained with reference to the drawings.

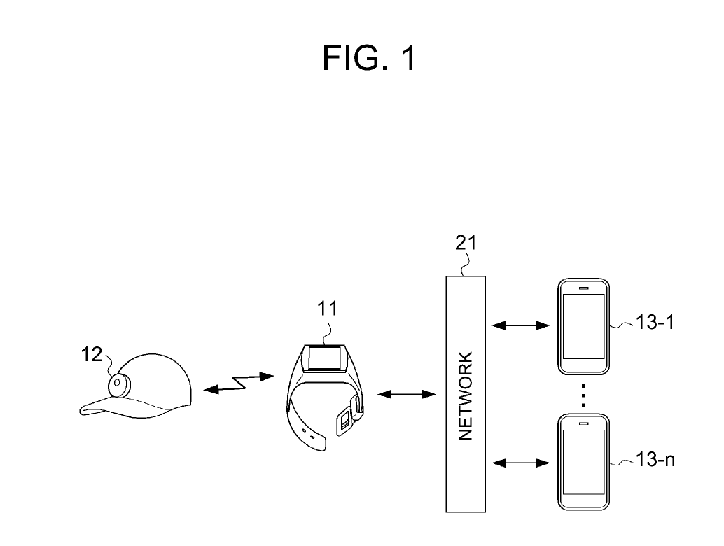

FIG. 1 shows a configuration of an image capture system according to an embodiment of the present invention.

The image capture system shown in FIG. 1 is provided with a wrist terminal 11 and an image capture apparatus 12.

The wrist terminal 11 is a wrist-type portable terminal fit to a user's arm, and as least has a function of communicating with an image capture apparatus 12 and an acquisition function of acquiring information indicating a current position based on a GPS signal from GPS (Global Positioning System).

It should be noted that a method of communicating between the wrist terminal 11 and the image capture apparatus 12 is not limited in particular. In the present embodiment, a method of using Near Field Communication is adopted.

Furthermore, in the present embodiment, the wrist terminal 11 has a function of communicating between each of other terminals 13-1 to 13-n (n is any integer value of greater than or equal to 1) via a network 21 including the Internet. It should be noted that a method of communicating via the network 21 for the wrist terminal 11 is not limited in particular. In the present embodiment, a method of communicating via wireless communication at an access point by way of Wireless LAN is employed.

The image capture apparatus 12 is configured as a small digital camera that can be mounted to a hat and the like as shown in FIG. 1, and can receive various instructions for image capturing by way of remote control. In other words, it becomes unnecessary to manually operate, for example, to press a shutter button by finger while holding the housing by hand conventionally.

However, the image capture apparatus 12 is also provided with an operation unit corresponding to a shutter button. Therefore, it is possible for a user to perform an operation manually for instructing to capture images.

Each of the other terminals 13-1 to 13-n is configured by, for example, a smart phone, mobile phone, or personal computer owned by a plurality of other users.

It should be noted that the other terminals 13-1 to 13-n are collectively referred to as “other terminal 13” unless it is necessary to distinguish each of the other terminals 13-1 to 13-n individually.

In the present embodiment, the image capture system shown in FIG. 1 is applied as follows.

In other words, it is supposed that a user puts a hat on to which the image capture apparatus 12 is mounted, and runs a predetermined distance while wearing the wrist terminal 11 on the user's arm.

As described in detail later, the wrist terminal 11 acquires information indicating a current position of the wrist terminal 11 based on the GPS signal received from GPS, estimates a user's running distance (a moving distance of the image capture apparatus 12) based on the information thus acquired, and instructs the image capture apparatus 2 to capture images each time the running distance reaches a set distance. When the image capture apparatus 12 receives an instruction to capture images from the wrist terminal 11, it starts an operation of image capturing, outputs captured image data, and transmits to the wrist terminal 11. When the wrist terminal 11 receives the captured image data, the wrist terminal 11 stores the data in the wrist terminal 11 and transmits to the other terminal 13 via the network 21.

The abovementioned operations are repeated during the user's running. It should be noted that the operation (processing) at the wrist terminal 11 side among the abovementioned repeated operations is referred to as “image capture control processing”. When the image capture control processing is executed, a captured image that is created in the user's point of view while running (more precisely, a captured image in which a subject in front of the hat is captured) is acquired for each predetermined distance based on a set distance.

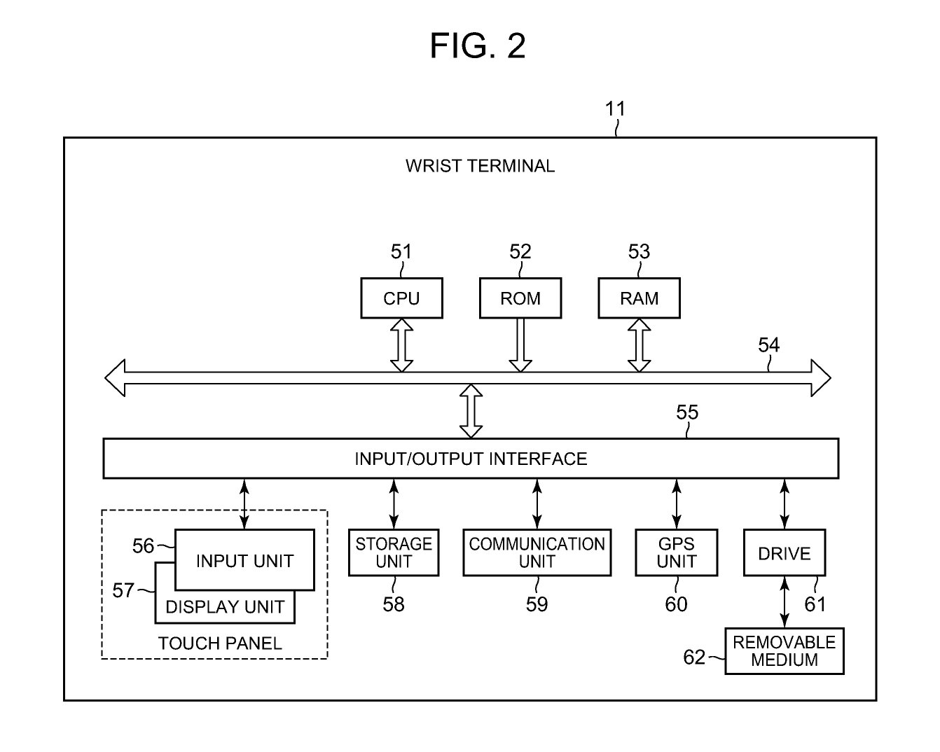

FIG. 2 is a block diagram showing a hardware configuration of a wrist terminal 11 according to an embodiment of an information processing apparatus of the present invention among the image capture system of FIG. 1.

The wrist terminal 11 includes a CPU (Central Processing Unit) 51, ROM (Read Only Memory) 52, RAM (Random Access Memory) 53, a bus 54, an Input/Output interface 55, an input unit 56, a display unit 57, a storage unit 58, a communication unit 59, a GPS unit 60, and a drive 61.

The CPU 51 executes various processing according to programs that are recorded in the ROM 52, or programs that are loaded from the storage unit 58 to the RAM 53.

The RAM 53 also stores data and the like necessary for the CPU 51 to execute the various processing, as appropriate.

The CPU 51, the ROM 52 and the RAM 53 are connected to one another via the bus 54. The input/output interface 55 is also connected to the bus 54. The input unit 56, the display unit 57, the storage unit 58, the communication unit 59, the GPS unit 60, and the drive 61 are connected to the input/output interface 55.

The input unit 56 is configured to include a capacitive or resistive position input sensor that is laminated on a display screen of the display unit 57. The input unit 56 detects the coordinates of a position where a touch operation is performed. In this regard, the touch operation refers to an operation of touching or approaching an object (a finger or stylus of a user) on the input unit 56.

The display unit 57 is configured by a display to display images.

In other words, in the present embodiment, a touch screen is configured with the input unit 56 and the display unit 57.

The storage unit 58 is configured by DRAM (Dynamic Random Access Memory) or the like, and stores data of various images.

The communication unit 59 wirelessly communicates with the wrist terminal 11 by way of wireless communication and executes communication with the other terminal 13 via the network 21 including the Internet by way of Wireless LAN.

When the GPS unit 60 receives the GPS signals from a plurality of GPS satellites, it creates information indicating a current position of the wrist terminal 11, more specifically, each of the pieces of information relating to latitude, longitude, and altitude (these pieces of information are collectively referred to as “positional information”) based on these GPS signals.

A removable medium 62 is installed in the drive 61, as appropriate. Programs that are read via the drive 62 from the removable medium 61 are installed in the storage unit 58, as necessary. Similarly to the storage unit 58, the removable medium 62 can also store a variety of data such as the image data stored in the storage unit 58.

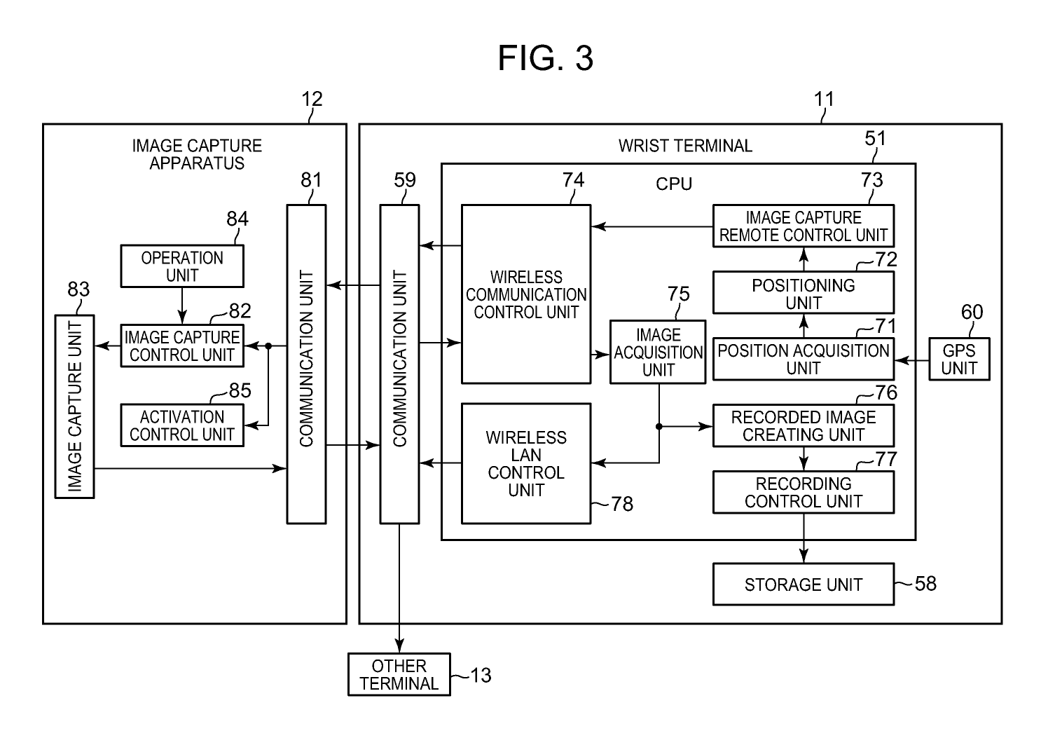

FIG. 3 is a functional block diagram showing a functional configuration for executing image capture control processing among the functional configurations of such a wrist terminal 11.

When the image capture control processing is executed, as shown in FIG. 3, a position acquisition unit 71, a positioning unit 72, an image capture remote control unit 73, a wireless communication control unit 74, an image acquisition unit 75, a recorded image creating unit 76, a recording control unit 77, and a Wireless LAN control unit 78 function in the CPU 51.

The position acquisition unit 71 acquires each piece of positional information sequentially created by the GPS unit 60 each time created.

The positioning unit 72 estimates a current position of the image capture apparatus 12 and a distance from a reference position (a moving distance of the image capture apparatus 12 from a reference position) based on each piece of positional information sequentially acquired by the position acquisition unit 71. The reference position is not limited in particular. In the present embodiment, a position where the user starts to run is employed.

The image capture remote control unit 73 executes remote control on the image capture apparatus 12.

For example, the image capture remote control unit 73 executes control to switch between an image capture operable state and a low consumption state of electric power (sleep mode) as operational states (modes) of the image capture apparatus 12. It should be noted that, hereinafter, shift of an operational state of the image capture apparatus 12 from the low consumption state of electric power to the image capture operable state is referred to as “activation”. Furthermore, the reverse shift, i.e. a shift of the operational state of the image capture apparatus 12 from the image capture operable state to the low consumption state of electric power is referred to as “shut down”.

Furthermore, the image capture remote control unit 73 performs operations to instruct the image capture apparatus 12 to start and finish capturing a still image or a moving image (instruction operations corresponding to pressing and releasing a shutter button).

More specifically, for example, in the present embodiment, the image capture remote control unit 73 activates the image capture apparatus 12 each time a distance calculated by the positioning unit 72 reaches a predetermined distance (for example, every 1 kilometer) and performs an instruction operation to start image capturing, thereby executing control to start an operation of image capturing by the image capture apparatus 12 (hereinafter, referred to as “activation and image capture control”). Then, when captured image data is transmitted to the wrist terminal 11 from the image capture apparatus 12, the image capture remote control unit 73 executes control to shut down the image capture apparatus 12 (hereinafter, referred to as “shut down control”). Since this remote control is repeatedly executed, captured images that are created in the user's point of view while running (more precisely, a captured image in which a subject in front of the hat is captured) is acquired for each predetermined distance and electric power saving of the image capture apparatus 12 is undertaken efficiently.

Furthermore, the image capture remote control unit 73 can perform various settings of the image capture apparatus 12 (for example, setting image quality, sound quality, and the like).

The wireless communication control unit 74 controls wireless communication with the image capture apparatus 12 via the communication unit 59 by way of wireless communication.

For example, the wireless communication control unit 74 executes control to wirelessly transmit various control signals necessary for various remote control by the image capture remote control unit 73 to the image capture apparatus 12 from the communication unit 59 by way of wireless communication. Furthermore, for example, the wireless communication control unit 74 executes control to cause the communication unit 59 to receive captured image data outputted from the image capture apparatus 12 by way of wireless communication.

The image acquisition unit 75 acquires captured image data of the image capture apparatus 12 which was received by the communication unit 59 by the control of the wireless communication control unit 74.

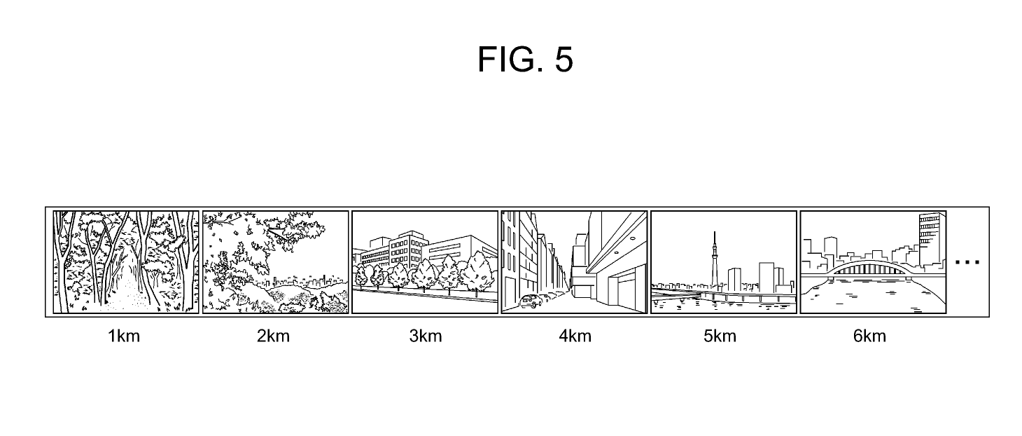

The recorded image creating unit 76 creates image data for recording based on captured image data acquired by the image acquisition unit 75. It should be noted that a specific example of an image for recording is described later with reference to FIG. 5, etc.

The recording control unit 77 executes control to cause the storage unit 58 or the removable media 62 to record image data for recording created by the recorded image creating unit 76.

The Wireless LAN control unit 78 controls to communicate with other terminal 13 via the communication unit 59 and the network 21 by way of Wireless LAN. For example, the Wireless LAN control unit 78 executes to cause the other terminal 13 to transmit the captured image data acquired by the image acquisition unit 75 via the communication unit 59 and the network 21 by way of Wireless LAN.

Furthermore, in a case in which such image capture control processing is executed in the wrist terminal 11, as shown in FIG. 3, a communication unit 81, an image capture control unit 82, an image capture unit 83, an operation unit 84, and an activation control unit 85 function in the image capture apparatus 12.

The communication unit 81 at least has a function of controlling wireless communication with the wrist terminal 11 by way of wireless communication and has a function of controlling communication with the other terminal and the like via the network 21 including the Internet by way of Wireless LAN as necessary.

The image capture control unit 82 executes control of the image capture apparatus 12 relating to image capturing such as the start and end of an image capture operation of the image capture unit 83 based on a remote instruction operation from the wrist terminal 11 or a direct instruction operation by a user, setting of various conditions of the image capture unit 83, and the like.

The image capture unit 83 captures a subject, outputs a digital signal (image signal) of an image including a figure of the subject as captured image data, and transmits to the wrist terminal 11 via the communication unit 81.

The operation unit 84 consists of various operators including a shutter button, receives a direct operation from the user, and supplies information indicating the operation to the image capture control unit 82. In other words, the image capture apparatus 12 according to the present embodiment can receive a remote operation (automatic operation) from the wrist terminal 11 and receive a direct operation (manual operation) from the user to the operation unit 84.

The activation control unit 85 executes control to switch between the image capture operable state and the low consumption state of electric power (sleep state), i.e. control to activate and shut down, as operation states of the image capture apparatus 12, based on a remote instruction operation from the wrist terminal 11 or a direct instruction operation from a user to the operation unit 84.

Next, image capture control processing executed by the wrist terminal 11 having such a functional configuration is explained.

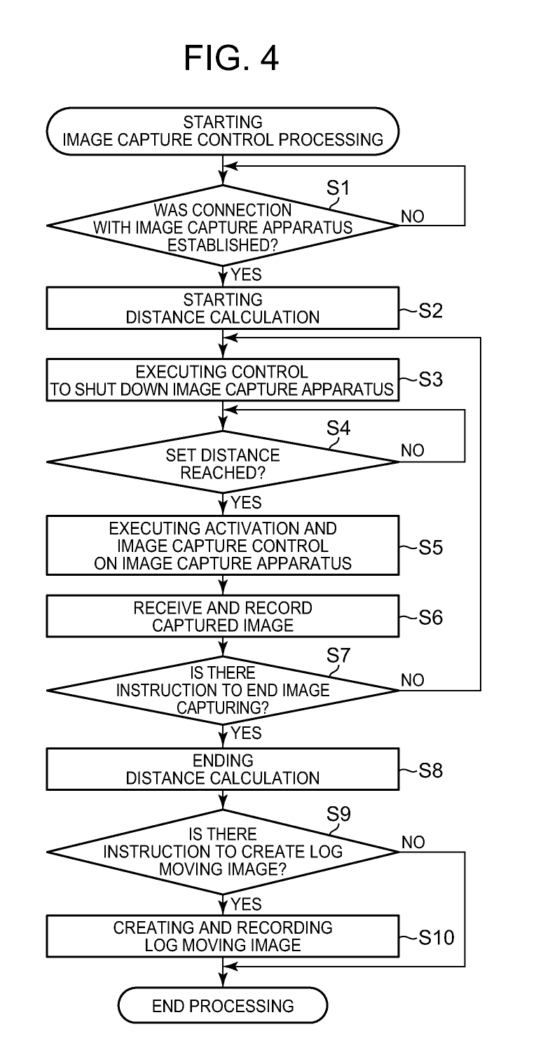

FIG. 4 is a flowchart showing an example of a flow of image capture control processing executed by the wrist terminal 11 of FIG. 2 having the functional configuration of FIG. 3.

When the power is supplied to the wrist terminal 11 and a predetermined condition is satisfied, the image capture control processing starts and the following processing of Step S1 and higher is executed.

In Step S1, the wireless communication control unit 74 judges whether a connection with the image capture apparatus 12 was established.

In a case in which the wireless communication between the wrist terminal 11 and the image capture apparatus 12 by way of wireless communication has not been established, it is judged as NO in Step S1 and the processing returns to Step S1 again. In other words, in a state in which the wireless communication between the wrist terminal 11 and the image capture apparatus 12 by way of wireless communication has not been established yet, the judging processing of Step S1 is repeatedly executed and the image capture control processing enters a standby state.

In the present embodiment, the wireless communication between the wrist terminal 11 and the image capture apparatus 12 by way of wireless communication is established by making a so-called pairing operation by way of wireless communication before starting running in a state in which a user wears a hat to which the image capture apparatus 12 is attached and the wrist terminal 11 is fit to the user's arm. Once the wireless communication is established, it is judged as YES in Step S1 and the processing advances to Step S2.

In Step S2, the positioning unit 72 starts a distance calculation.

In Step S3, the image capture remote control unit 73 executes control to shut down the image capture apparatus 12 as a remote control to the image capture apparatus 12 via the wireless communication control unit 74 and the communication unit 59. With such a configuration, the image capture apparatus 12 is shut down and shifts to the low consumption mode of electric power, which can achieve electric power saving.

In Step S4, the positioning unit 72 judges whether the distance thus calculated reaches a set distance.

In a case in which the distance thus calculated is less than the set distance (for example, 1 kilometer), it is judged as NO in Step S4 and the processing returns to Step S4. In other words, a current position changes as the user runs, and if the change amount (a running distance=an estimated distance calculated) is less than the set distance, the judging processing of Step S4 is repeatedly executed and the image capture control processing enters a standby state.

Since the estimated distance calculated reaches the set distance when the user runs the set distance, it is judged as YES in Step S4 and the processing advances to Step S5.

In Step S5, the image capture remote control unit 73 transmits an instruction of activating and image capturing processing to the image capture apparatus 12 via the wireless communication control unit 74 and the communication unit 59.

When the image capture apparatus 12 receives the instruction of activating and image capturing processing from the communication unit 59, the image capture apparatus 12 activates the apparatus, executes the image capture processing, and transmits captured image data to the wrist terminal 11. The captured image data transmitted at this time is data of a captured image that is created in the user's point of view as the user runs the set distance (more precisely, a captured image in which a subject in front of the hat is captured).

In Step S6, the image acquisition unit 75 receives the captured image data via the communication unit 59 and the wireless communication control unit 74, the recorded image creating unit 76 creates recorded image data based on the captured image data, and the recording control unit 77 executes control to cause the storage unit 58 to store the recorded image data.

It should be noted that the recorded image data is acceptable so long as it is based on captured image data, and thus may be various corrected data or may be combined data. However, for the purpose of facilitating the descriptions, the captured image data is stored as-is in the storage unit 58 as recorded image data.

The image capture remote control unit 73 judges whether there is an instruction for ending image capturing.

The instruction for ending image capturing is not limited in particular, and thus satisfying a predetermined condition may be recognized as the instruction for ending image capturing. Here, an explicit instruction operation to the input unit 56 by the user is employed as the instruction for ending image capturing.

Therefore, if such an instruction operation is not made, it is judged as NO in Step S7 and the processing returns to Step S3, and the subsequent processing is repeated. In other words, each time loop processing from Steps S3 to S7 is repeated once, data of a captured image that is created in the user's point of view as the user runs the set distance (more precisely, a captured image in which a subject in front of the hat is captured) is acquired and stored in the storage unit 58.

Here, when the loop processing from Steps S3 to S7 is executed once, a distance calculated by the positioning unit 72 may be reset or a new distance may be set as a set distance. For example, as with the captured image data for every 1 kilometer running, if captured image data for every predetermined distance is desired, a set distance may be fixed to 1 kilometer and a distance calculated may be reset at each time. On the other hand, as with each piece of captured image data such as 1 kilometer, 5 kilometer, 10 kilometer, the halfway point, and the finish line (42.195 kilometer) in a full marathon, if a plurality of pieces of image captured data of which distances are not equal is desired, a distance calculated may not be reset and may be cumulatively added, and a set distance may be updated sequentially.

In a case in which the abovementioned explicit operation is made to the input unit 56 when, for example, the user finishes running, it is judged as YES in Step S7 and the processing advances to Step S8.

In Step S8, the positioning unit 72 ends distance calculation.

In Step S9, the recorded image creating unit 76 judges whether there is an instruction to create a log moving image.

The instruction to create a log moving image is not limited in particular, and thus satisfying a predetermined condition may be recognized as the instruction to create a log moving image. Here, an explicit instruction operation to the input unit 56 by the user is employed as the instruction to create a log moving image.

Therefore, if such an instruction operation is not made, it is judged as NO in Step S9 and the processing of Step S10 is not executed, i.e. a log moving image is not created. Then, the image capture control processing ends.

On the other hand, if such an instruction operation is made, it is judged as YES in Step S9 and the processing advances to Step S10.

In Step S10, the recorded image creating unit 76 creates data of a moving image for recording in which a user running is recorded (hereinafter, referred to as “log moving image”) based on a plurality of pieces of captured image data acquired by the loop processing of Steps S3 to S7, and the recording control unit 77 stores the data in the storage unit 58. In this way, the image capture control processing ends.

FIG. 5 is a schematic view showing a summary of log moving images created in the processing of Step S10.

In an example of FIG. 5, a moving image that is created by combining in series each of captured images captured for every 1 kilometer while a user is running is employed as a log moving image.

Here, as described above, since a moving distance of the image capture apparatus 12 is calculated based on information of a current position received by the wrist terminal from GPS, a log moving image photographed with a precise distance interval is acquired.

It should be noted that the present invention is not to be limited to the aforementioned embodiment, and that modifications, improvements, etc. within a scope that can achieve the object of the present invention are also included in the present invention.

In other words, the information processing apparatus to which the present invention is applied can also be embodied as various embodiments having the following configurations including the wrist terminal 11 as in the abovementioned embodiments.

The information processing apparatus such as the wrist terminal 11 includes the communication unit 59, the positioning unit 72, and the image capture remote control unit 73.

The communication unit 59 communicates with an external image capture apparatus such as the image capture apparatus 12.

The positioning unit 72 estimates a moving distance of the image capture apparatus.

The image capture remote control unit 73 remotely controls an image capturing operation of the image capture apparatus via the communication unit 59 based on the moving distance estimated by the positioning unit 72.

With such a configuration, a technology of recording captured images that according to various moving distances for log, in a case in which the image capture apparatus captures images a plurality of times while moving, is realized.

Furthermore, as in the wrist terminal 11 and the like serving as an information processing apparatus, so long as having a function to wirelessly communicate with a base station by way of Wireless LAN and the like, since its position can be identified from the base station even if the image capture apparatus is positioned in a tunnel where GPS cannot identify, for example, the positioning unit 72 can estimate and calculate a moving distance precisely at any time.

Furthermore, in view of an external image capture apparatus, since it works without the GPS function even if it has the GPS function, it becomes possible to save electric power consumption in proportion.

The image capture remote control unit 73 can perform remote control via the communication unit 59 so as to cause the image capture apparatus to capture an image each time a moving distance reaches a set distance.

With such a configuration, if a set distance is a fixed distance such as 1 kilometer, for example, captured image data that is captured each time the image capture apparatus moves 1 kilometer is acquired for log. Even if the set distance has not been updated, for example, as with each piece of captured image data such as 1 kilometer, 5 kilometer, 10 kilometer, the halfway point, and the finish line (42.195 kilometer) in a full marathon, a plurality of pieces of image captured data of which distances are not equal is acquired for log.

The image capture remote control unit 73 can shift an operation mode of the image capture apparatus to the electric power low consumption mode after the image capture apparatus finishes image capturing and can further perform remote control to shift the operation mode of the image capture apparatus from the low consumption mode of electric power to a normal mode each time a moving distance reaches a set distance.

With such a configuration, since the image capture apparatus is set to a normal mode while operating image capturing and to the low consumption mode while not operating image capturing, the image capture apparatus can achieve electric power consumption savings effectively.

The information processing apparatus such as the wrist terminal 11 and the like can include the recorded image creating unit 76.

With such a configuration, the communication unit 59 sequentially receives captured image data that are captured each time a moving distance reaches a set distance by way of remote control of the image capture remote control unit 73. Then, the recorded image creating unit 76 can create image data for log based on the captured image data that were sequentially received by the communication unit 59.

In this way, data such as of a moving image and the like that is created by combining in series each of the captured images captured for every predetermined distance (for example, 1 kilometer) is created as image data for log. Here, since the positioning unit 72 calculates a distance based on information indicating a current position received from the GPS, for example, it is possible to acquire image data for log that is photographed with a precise distance interval.

Furthermore, the recorded image creating unit 76 can also create image data for log by weighting according to a moving distance. For example, in a case of captured image data for log in the abovementioned full marathon, the recorded image generating unit 76 uses weighting in such a manner that weighting is greater as approaching the finish line, and moving image data with which a replay time is associated according to the weighting is created as image data for log. With such a configuration, a moving image that is replayed longer with being closer to the finish line is acquired as log.

In this way, the recorded image generating unit 76 can also create various image data for log by appropriately combining various elements including a moving distance.

The communication unit 59 receives captured image data outputted from the image capture apparatus of which an image capturing operation is remotely controlled by the image capture remote control unit 73, and further can also forward to the other terminal 13 via the network 21 such as the Internet.

Here, captured image data forwarded may be still image data or moving image data (so-called live view image) during a predetermined period (for example, 5 minutes after reaching a set distance). In other words, each time the moving distance of the image capture apparatus reaches a set distance, an image in which the state being captured by the image capture apparatus (the user's point of view while running, in the abovementioned example) is reflected is streamingly distributed to the other terminal 13 held by another user.

With such a configuration using a network, various types of cooperation with the image capture system according to one embodiment of the present invention becomes facilitated.

Furthermore, although only the remote control of the operation of image capturing of the image capture apparatus by the image capture remote control unit 73 is the instruction (trigger) to start image capturing, the present invention is not limited thereto and, for example, it is possible to employ an instruction to end image capturing at the time of moving a predetermined distance after starting image capturing. With such a configuration, it is possible to readily acquire a moving image of moving 100 meters after moving 1 kilometer, for example.

Furthermore, although the data for log moving image (image for log) is an aggregation of the captured image data captured by the image capture apparatus 12 based on the remote control of the image capture remote control unit 73 in the abovementioned embodiment, the present invention is not limited thereto, and captured image data captured by the image capture apparatus 12 based on direct operation (manual operation) by the user to the operation unit 84 may be included.

With such a configuration, since it is possible to include not only a captured image for every predetermined distance, but also a captured image captured by the user at a desired timing, image data for log that is more flexible and preferable for the user can be acquired.

Furthermore, although the image capture apparatus 12 is attached to a hat of the user in the abovementioned embodiment and thus moved with the user, the present invention is not limited thereto, and may be fixed.

In such a case, it is possible to receive positional information in real time from the information processing apparatus such as the wrist terminal 11 and the like, even if the image capture apparatus 12 is fixed at a place where the GPS signal cannot be received such as inside a building.

In the aforementioned embodiments, a wrist terminal 11 has been described as an example of the information processing apparatus to which the present invention is applied; however, the present invention is not particularly limited thereto.

For example, the present invention can be applied to any electronic apparatus in general having a position acquisition function. More specifically, for example, the present invention can be applied to a portable terminal such as smart phone, a portable navigation device, a cell phone device, a portable gaming device, a digital camera, a lap-top personal computer, a printer, a television, a video camera, and the like.

The processing sequence described above can be executed by hardware, and can also be executed by software.

In other words, the hardware configuration shown in FIG. 2 is merely an illustrative example, and the present invention is not particularly limited thereto. More specifically, the types of functional blocks employed to realize the above-described functions are not particularly limited to the example shown in FIG. 3, so long as the wrist terminal 11 can be provided with the functions enabling the aforementioned processing sequence to be executed in its entirety.

A single functional block may be configured by a single piece of hardware, a single installation of software, or any combination thereof.

In a case in which the processing sequence is executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by the removable medium 62 shown in FIG. 1 distributed separately from the device main body for supplying the program to a user, but also can be constituted by a storage medium or the like supplied to the user in a state incorporated in the device main body in advance. The removable medium 62 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), or the like. The magnetic optical disk is composed of an MD (Mini-Disk) or the like. The storage medium supplied to the user in a state incorporated in the device main body in advance may include, for example, the ROM 52 shown in FIG. 1, a hard disk included in the storage unit 58 shown in FIG. 2 or the like, in which the program is recorded.

It should be noted that, in the present specification, the steps describing the program recorded in the storage medium include not only the processing executed in a time series following this order, but also processing executed in parallel or individually, which is not necessarily executed in a time series.

In addition, in the present specification, a term system shall mean a general device configured from a plurality of devices, a plurality of means, and the like.

Although some embodiments of the present invention have been described above, the embodiments are merely exemplification, and do not limit the technical scope of the present invention. Other various embodiments can be employed for the present invention, and various modifications such as omission and replacement are possible without departing from the sprits of the present invention. Such embodiments and modifications are included in the scope of the invention and the summary described in the present specification, and are included in the invention recited in the claims as well as the equivalent scope thereof.

What is claimed is:

1. An information processing apparatus comprising:
a communication unit that communicates with an external image capture apparatus;
a positioning unit that estimates a moving distance of the image capture apparatus; and
a transmission unit that transmits to the external image capture apparatus, an instruction to control the image capture apparatus, depending on the moving distance estimated by the positioning unit, via the communication unit.

2. The information processing apparatus according to claim 1, wherein
the transmission unit transmits an instruction to cause the image capture apparatus to start image capturing when the moving distance reaches a set distance that is set in advance.

3. The information processing apparatus according to claim 1, wherein
the transmission unit shifts to an operation mode of the image capture apparatus to a low consumption mode of electric power after the image capturing by the image capture apparatus ends, and
transmits an instruction to cause the operation mode of the image capture apparatus to shift from the low consumption mode to a normal mode when the moving distance reaches the set distance that is set in advance.

4. The information processing apparatus according to claim 1,
wherein the communication unit receives image data captured according to the instruction transmitted by the transmission unit from the image capture apparatus,
the information processing apparatus further comprising a recorded image creating unit that creates image data for log based on the image data received by the communication unit.

5. The information processing apparatus according to claim 1, wherein
the communication unit forwards the image data received from the image capture apparatus to another apparatus.

6. The information processing apparatus according to claim 1, further comprising:
an acquisition unit that acquires information indicating a current position from GPS satellites, and
a calculation unit that estimates the moving distance of the image capture apparatus based on the information acquired by acquisition unit.

7. An image capture system to which an image capture apparatus and a terminal including a positioning unit that estimates a moving distance of the image capture apparatus are communicably connected via a communication unit, wherein the terminal includes a transmission unit that transmits an instruction to control the image capture apparatus, based on the moving distance estimated by the positioning unit, to the image capture apparatus via the communication unit, and
the image capture apparatus includes a captured image transmission unit that transmits the image captured to the terminal.

8. An information processing method executed by an information processing apparatus including a communication unit that communicates with an external image capture apparatus, comprising:
a positioning step of estimating a moving distance of the image capture apparatus; and
a transmitting step of transmitting an instruction to control the image capture apparatus, based on the moving distance estimated by the positioning step, to the image capture apparatus via the communication unit.

9. A non-transitory storage medium encoded with a computer-readable program that enables a computer included in an information processing apparatus that communicates with an external image capture apparatus to execute functions as:
a positioning unit of estimating a moving distance of the image capture apparatus; and
a transmitting unit of transmitting an instruction to control the image capture apparatus, based on the moving distance estimated by the positioning unit, to the image capture apparatus via the communication unit.
